(19) United States
(12) Patent Application Publication
(10) Pub. No.: US 2023/0307651 A1
(43) Pub. Date: Sep. 28, 2023

(54) CARBONACEOUS MATERIAL DISPERSION FOR ALL-SOLID LITHIUM ION RECHARGEABLE BATTERY, AND SLURRY FOR ELECTRODE OF ALL-SOLID LITHIUM ION RECHARGEABLE BATTERY

(71) Applicant: REFINE HOLDINGS CO., LTD., Gifu (JP)

(72) Inventors: Kensuke FUKASAWA, Tokyo (JP); Masaru NAKAJO, Tokyo (JP); Tomokiyo TAKEYAMA, Tokyo (JP)

(73) Assignee: REFINE HOLDINGS CO., LTD., Gifu (JP)

(21) Appl. No.: 18/020,162

(22) PCT Filed: Aug. 6, 2021
(86) PCT No.: PCT/JP2021/029408

§ 371 Date: Feb. 7, 2023

(30) Foreign Application Priority Data
Aug. 7, 2020 (JP) 2020-135224
Jun. 2, 2021 (JP) 2021-093200

(51) Int. Cl. H01M 4/62; H01M 10/0525

(52) U.S. Cl. CPC H01M 4/625; H01M 10/0525

(57) ABSTRACT

Disclosed are a carbonaceous material dispersion, which is a carbonaceous material dispersion with carbonaceous materials and dispersing agents dispersed in a dispersion medium for an all-solid lithium-ion rechargeable battery. The dispersion medium contains at least an ester solvent, and the dispersing agent contains at least polyvinyl butyral; in the dispersion the carbonaceous material accounts for 10 to 25% of the total mass of the dispersion, and the dispersing agent is 5 to 40% of the carbonaceous material by mass; and the carbonaceous material dispersion has a viscosity of not more than 500 mPa·s at 25° C.

### TECHNICAL FIELD

The present disclosure relates to a carbonaceous material dispersion for an all-solid lithium-ion rechargeable battery and a slurry for an electrode of an all-solid lithium-ion rechargeable battery. In particular, the present disclosure relates to a carbonaceous material dispersion for an all-solid lithium-ion rechargeable battery, which, when used as a conductive additive, can inhibit the deterioration of solid electrolyte, uniformly disperse the carbonaceous material with high concentration, and disperse solid components with low viscosity and high concentration when mixed with electrode active materials. The present disclosure further relaters to a slurry for an electrode of an all-solid lithium-ion rechargeable battery using the carbonaceous material dispersion for the all-solid lithium-ion rechargeable battery.

### BACKGROUND

In recent years, lithium-ion rechargeable batteries with high capacity and high output have been widely used in the field of electronic devices, such as portable personal computers, smart phones and mobile phones, and the field of vehicles, such as electric vehicles and hybrid vehicles.

For the lithium-ion rechargeable batteries, an electrolyte, such as a flammable organic solvent, is used in a dilution solvent as a medium for ion migration in the past, and problems, such as leakage, fire and explosion, of the electrolyte may occur in the battery in which such electrolyte is used.

In order to solve the problems, an all-solid lithium-ion rechargeable battery is being developed, in which a solid electrolyte is used instead of the liquid electrolyte, and other elements are all composed of a solid. The solid electrolyte and lithium ions in the all-solid lithium-ion rechargeable battery have a very small charge transfer resistance, enabling the battery to have a reduced internal resistance. In addition, the use of the solid electrolyte reduces the risk of fire, and no leakage will occur. In addition, problems due to corrosion, such as battery performance deterioration, are alleviated.

The all-solid lithium-ion rechargeable battery comprises: a cathode layer and an anode layer; and a solid electrolyte layer arranged between the cathode layer and the anode layer, where the electrolyte is composed of a solid.

As the solid electrolyte layer, when the electrode layer is formed by an electrode active material only through powder molding, because the electrolyte is solid, the electrolyte cannot penetrate into the electrode layer easily, the interface between the electrode active material and the electrolyte is reduced, resulting in degraded battery performance. In addition, because the electrode layer is composed of the solid, the electrode lacks flexibility and processability, and has poor operability.

Aiming at the problem, the following solution is proposed: a slurry prepared by dispersing an electrode active material, a solid electrolyte material and a binder into a solvent the electrode layer is composed of.

In addition, in the existing lithium-ion rechargeable battery, the following electrode slurries were used: an electrode slurry formed by dispersing an active material, a conductive assistant and the like into a polymer solution formed by dissolving polyvinylidene fluoride (PVDF) in an N-methyl-2-pyrrolidone (NMP) solvent as a binder; and an electrode slurry formed by dispersing an active material and a conductive additive into an aqueous solution formed by emulsifying styrene-butadiene rubber (SBR) in an aqueous solvent as a binder, and adding a thickener such as carboxymethyl cellulose (CMC). However, in the all-solid lithium-ion rechargeable battery, if the solid electrolyte is exposed to a highly polar solvent, the ionic conductivity is reduced, and sufficient battery performance cannot be obtained, so NMP and water cannot be used as the solvent of the electrode slurry for electrode manufacturing.

For example, in Patent literature 1, as a slurry composed of a cathode active material, a solid electrolyte material, a binder, a conductive agent and a solvent and used for forming a cathode mixture layer of a cathode mixture of the all-solid lithium-ion rechargeable battery, the following combination is proposed: the binder is a styrene-containing binder resin, such as styrene-butadiene rubber (SBR) and a styrene-ethylene-butylene-styrene block copolymer (SEBS), the conductive agent is a carbon fiber, and in addition, the solvent is a non-polar solvent, such as n-alkane comprising heptane, methylbenzene and xylene. In addition, the following content is shown: thus, a cathode current collector with improved conductivity and capable of forming a cathode mixture layer with high flexibility and strength is obtained.

However, the following content is reported at the same time: for example, when carbon black is used as the conductive agent instead of the expensive carbon fiber, if the styrene-containing binder resin is used as the binder in this way, for example, compared with the cathode mixture layer only added with silicone polymer, the resistance is increased.

In addition, in Patent literature 2, as a slurry composed of an anode active material, a solid electrolyte material, a binder, a conductive agent and a solvent and used for forming an anode mixture layer of an anode mixture of the all-solid lithium-ion rechargeable battery, the following combination is proposed, which is composed of the following components: an anode active material containing Si; a solid electrolyte containing a sulfide solid electrolyte; a conductive material composed of a fibrous carbonaceous material with a carbon six-membered ring; a binder composed of polymer compounds with aromatic rings, such as SBR and SEBS; and at least one solvent selected from groups consisting of 1,3,5-trimethyl benzene, isopropyl benzene and methylphenyl ether. In addition, the following main idea is disclosed: the binder may contain polymer compounds other than those with aromatic rings, such as polyvinylidene fluoride (PVDF), polytetrafluoroethylene (PTFE), butylene rubber (BR), polyvinyl butyral (PVB) and propylene resin, within a range not more than 5% by mass. Moreover, the following content is shown: through the combination, in the case that the anode active material containing Si is used, when the anode mixture is repeatedly charged and discharged, a part causing poor contact between the conductive material and the anode active material due to repeated charging and discharging is suppressed, and the increase of internal resistance can be suppressed.

However, the following content is reported at the same time: in this case, considering the dispersibility when the carbon fiber with carbon six-membered ring is used as the conductive agent, the binder composed of polymer compounds with aromatic rings, such as SBR and SEBS, and the solvent with aromatic ring, such as 1,3,5-trimethyl benzene, isopropyl benzene and methylphenyl ether, are selected. For example, when a scaly carbonaceous material is used as the conductive agent, even if the binder and the solvent are materials with aromatic rings equally, the increase of internal resistance cannot be suppressed.

In addition, in Patent literature 3, the following solution is proposed: for example, polyvinylidene fluoride, polytetrafluoroethylene, polyvinyl acetate, polymethyl methacrylate, polyethylene, and the like are used as binding materials, and for example, aromatic hydrocarbons, such as toluene, xylene, decalin, tetrahydronaphthalene, saturated hydrocarbons, such as hexane, pentane, ethylhexyl, heptane, decane, cyclohexane, and unsaturated hydrocarbons, such as hexene, heptene and cyclohexene, are used as solvents, so as to form the cathode mixture layer through wet mechanochemical treatment.

Moreover, in Patent literature 4, the following content is disclosed: in the preparation of the slurry for the all-solid lithium-ion rechargeable battery, butyl butyrate, heptane, and the like were used as solvents with low polarity in the past, but due to insufficient affinity with PVDF, molecular chains of PVDF in the solvents could not be fully extended, the viscosity of the electrode slurry could not be sufficiently increased, the electrode slurry could not be uniformly coated, unevenness was generated in the electrode, and the battery performance was degraded. To solve these problems, an acrylic acid copolymer with a specified structure is used as the binding material, and butyl ether (butyl butyrate, butyl propionate and butyl valerate) and alkane (hexane, cyclohexane, heptane, cycloheptane, octane and cyclooctane) solvents are used as the solvents.

### EXISTING TECHNICAL LITERATURES

### Patent Literatures

Patent literature 1: Japanese patent application laid-open No. 2010-262764

Patent literature 2: Japanese patent application laid-open No. 2019-125481

Patent literature 3: Japanese patent application laid-open No. 2013-222501

Patent literature 4: Japanese patent application laid-open No. 2020-21581

### SUMMARY

### Technical Problem to be Solved by the Present Disclosure

However, as to a slurry for an electrode of an all-solid lithium-ion rechargeable battery, or a carbonaceous material dispersion formed by dispersing a carbonaceous material used for preparing the slurry for the electrode of the all-solid lithium-ion rechargeable battery in a solvent, when the combination of the solvent and binder of the above-mentioned existing art is used, the problem of solid electrolyte deterioration may occur. Moreover, it is difficult to uniformly disperse the carbonaceous material in the slurry or in the dispersion at a high concentration, and when mixed with electrode active materials, it is not possible to disperse solid components with low viscosity and high concentration, and it is not possible to sufficiently improve characteristics of the obtained all-solid lithium-ion rechargeable battery, such as charge-discharge characteristics, cycle characteristics and electrode conductivity, especially the conductivity of the all-solid lithium-ion rechargeable battery.

Therefore, the technical matter of the present disclosure is to provide a carbonaceous material dispersion for an all-solid lithium-ion rechargeable battery and a slurry for an electrode of an all-solid lithium-ion rechargeable battery which can solve the above technical problem. Moreover, the technical problem to be solved by the present disclosure is to provide a carbonaceous material dispersion for an all-solid lithium-ion rechargeable battery, which, when being used as a conductive additive, can inhibit the deterioration of solid electrolyte, uniformly disperse the carbonaceous material with high concentration, and can exhibit excellent conductivity, and a slurry for an electrode of an all-solid lithium-ion rechargeable battery using the carbonaceous material dispersion for the all-solid lithium-ion rechargeable battery.

### Schemes Used to Solve the Technical Problem

In order to solve the technical problem above, the inventors of the present invention, after intensive discussion and research, have found the following facts and realized the present invention: as a carbonaceous material dispersion for an all-solid lithium-ion rechargeable battery, a dispersing agent containing at least polyvinyl butyral is mixed in a carbonaceous material, especially carbon black in a specified ratio as a dispersing agent, and an ester solvent is used as a solvent, so that the deterioration of solid electrolyte can be inhibited, and the carbonaceous material is uniformly dispersed at a high concentration, and excellent conductivity can be exerted.

That is, the present disclosure for solving the above technical problem relates to a carbonaceous material dispersion, which is a carbonaceous material dispersion for an all-solid lithium-ion rechargeable battery formed by dispersing a carbonaceous material and a dispersing agent in a dispersion medium, and is characterized in that: the dispersion medium contains at least an ester solvent, the dispersing agent contains at least polyvinyl butyral, and the carbonaceous material in the dispersion accounts for 10 to 25% of the total mass of the dispersion. In addition, the dispersing agent is 5 to 40% of the carbonaceous material by mass, and the carbonaceous material dispersion has a viscosity of not more than 500 mPa·s at 25° C.

In an embodiment of the carbonaceous material dispersion according to the present disclosure, a carbonaceous material dispersion is provided, where the dispersing agent is not less than 5% and less than 20% of the carbonaceous material by mass.

In another embodiment of the carbonaceous material dispersion according to the present disclosure, a carbonaceous material dispersion is provided, where the dispersing agent is 20 to 40% of the carbonaceous material by mass.

In an embodiment of the carbonaceous material dispersion according to the present disclosure, a carbonaceous material dispersion is provided, where the carbonaceous material dispersion has a viscoelasticity with a minimum value in a shearing velocity range of 10 to 1,000 s⁻¹ at 25° C.

In an embodiment of the carbonaceous material dispersion according to the present disclosure, a carbonaceous material dispersion is provided, where the dispersion medium contains an ester solvent accounting for not less than 10% of the dispersion medium by mass.

In an embodiment of the carbonaceous material dispersion according to the present disclosure, a carbonaceous material dispersion is provided, where the ester solvent is at least one selected from the group consisting of n-propyl acetate, butyl butyrate, butyl valerate, butyl hexanoate, amyl butyrate, amyl valerate, amyl caproate, hexyl butyrate, hexyl valerate and hexyl hexanoate.

In an embodiment of the carbonaceous material dispersion according to the present disclosure, a carbonaceous material dispersion is provided, where the ester solvent is butyl butyrate.

In an embodiment of the carbonaceous material dispersion according to the present disclosure, a carbonaceous material dispersion is provided, where the carbonaceous material is carbon black.

In an embodiment of the carbonaceous material dispersion according to the present disclosure, a carbonaceous material dispersion is further provided, where the carbon black is acetylene black.

In an embodiment of the carbonaceous material dispersion according to the present disclosure, a carbonaceous material dispersion is provided, where the carbonaceous material dispersion further contains a pH regulator.

Moreover, the present disclosure for solving the above technical problem also relates to a slurry for an electrode of an all-solid lithium-ion rechargeable battery, the slurry for the electrode of the all-solid lithium-ion rechargeable battery includes a carbonaceous material, a dispersing agent, a binder resin and a cathode active material or an anode active material mixed in a dispersion medium.

The dispersion medium contains at least an ester solvent, the dispersing agent contains at least polyvinyl butyral, and moreover, in the solid components of the slurry, the dispersing agent is 5 to 40% of the carbonaceous material by mass.

In an embodiment of the electrode slurry for the all-solid lithium-ion rechargeable battery according to the present disclosure, a carbonaceous material dispersion is provided, where the dispersing agent is not less than 5% and less than 20% of the carbonaceous material by mass.

In an embodiment of the slurry for the electrode of the all-solid lithium-ion rechargeable battery according to the present disclosure, a slurry for an electrode of an all-solid lithium-ion rechargeable battery is provided, where, when the solid components of the slurry have a concentration of 65 to 75% by mass, the slurry has a viscosity of 500 to 5,000 mPa·s at 25° C.

In an embodiment of the slurry for the electrode of the all-solid lithium-ion rechargeable battery according to the present disclosure, a carbonaceous material dispersion is provided, where the dispersing agent is 20 to 40% of the carbonaceous material by mass.

In an embodiment of the slurry for the electrode of the all-solid lithium-ion rechargeable battery according to the present disclosure, a slurry for an electrode of an all-solid lithium-ion rechargeable battery is provided, where, when the solid components of the slurry have a concentration of 77 to 87% by mass, the slurry has a viscosity of 1,000 to 10,000 mPa·s at 25° C.

### Inventive Effects

According to the present disclosure, the present disclosure aims to provide a carbonaceous material dispersion for an all-solid lithium-ion rechargeable battery, which, when used as a conductive additive, can inhibit the deterioration of solid electrolyte, uniformly disperse the carbonaceous material with high concentration, and can take advantage of the excellent conductivity. The slurry for the electrode of an all-solid lithium-ion rechargeable battery using the carbonaceous material dispersion results in the production of a rechargeable battery with excellent charge-discharge characteristics, cycle characteristics, electrode conductivity and stability characteristics.

### DETAILED DESCRIPTION

The present disclosure is described below in detail on the basis of embodiments.

<Carbonaceous material dispersion>

According to a first aspect of the present disclosure, a carbonaceous material dispersion for an all-solid lithium-ion rechargeable battery is a carbonaceous material dispersion for an all-solid lithium-ion rechargeable battery formed by a carbonaceous material and a dispersing agent dispersed in a dispersion medium, characterized in that: the dispersion medium contains at least an ester solvent, the dispersing agent contains at least polyvinyl butyral, and the carbonaceous material in the dispersion accounts for 10-25% of the dispersion by mass. In addition, the dispersing agent is 5 to 40% of the total mass of the carbonaceous material, and the carbonaceous material dispersion has a viscosity of not more than 500 mPa·s at 25° C.

First, the components for the carbonaceous material dispersion for the all-solid lithium-ion rechargeable battery according to the first aspect of the present disclosure will be described.

### (Carbonaceous Material)

The carbonaceous material used is not particularly limited as long as the carbonaceous material has conductivity and is in the form of powder, for example, carbon black (CB), carbon nanotube (CNT), carbon nanofiber (CNF), graphene, fullerene, natural graphite, artificial graphite, carbon which is difficult to graphitize, coke, graphite, and the like, and the above materials may be used alone or two or more of the above materials may be used together. CB is particularly preferred as the carbonaceous material. For example, CB may be furnace black, Ketjen black, channel black, acetylene black, thermal black, and the like, and any one of them may be used. For example, the acetylene black is preferred due to its inherently low metal component content in the production.

In addition, the carbon black which is usually oxidized or graphitized may also be used. The oxidation treatment of the carbon black is to treat the carbon black at high temperature in air, or to treat the carbon black with nitric acid, nitrogen dioxide, ozone, and the like, for example, to directly introduce (covalently bind) oxygen-containing polar functional groups such as phenol group, quinone group, carboxyl group and carbonyl group to a surface of the carbon black, so as to improve the dispersibility of the carbon black.

In addition, as required, the carbonaceous material may be subjected to dry magnetic separation to remove metal impurities mixed before the production of the carbonaceous material dispersion, and/or subjected to wet magnetic separation after the carbonaceous material is dispersed in an ester solvent to prepare a dispersion.

Here, in this specification, the “powdery” form of the carbonaceous material as a raw material dispersed in the dispersion medium is at least a form that can be dispersed in the following ester solvent, without particular limitation. Moreover, it is not particularly limited in shape, for example, the shape is not limited to a substantially spherical shape, and it may include an oval shape, a flake shape, a needle shape or a short fiber shape, an amorphous shape, and the like.

In addition, regarding the carbon black, for example, as explained in the website of Carbon Black Association (https://carbonblack.biz/index.html), a smallest unit of the carbon black that cannot be decomposed is aggregate (primary aggregate), a part (domain) of which is usually called particle. This particle is considered as the smallest unit particle in nanomaterials, but is only a part of the aggregate. The aggregate forms an agglomerate (secondary aggregate) through physical forces such as intermolecular force (van der Waals force). Moreover, in order to prevent dispersion and improve operability, carbon black products are mostly transported and sold in the form of processed particles such as liquid beads gained through compression treatment and granulation treatment.

For example, the carbon black products may include a primary aggregate with an average particle size of about 10 to 100 nm, a secondary aggregate with an average particle size of about 0.1 to 100 μm, or processed particles with an average particle size of about 500 to 5,000 μm, which are formed by compression treatment and granulation treatment in further consideration of operability.

In addition, from the point of view of the conductivity of the carbon black, conductive carbon particles are preferably aggregates with chain or cluster structures formed by connecting primary particles to a certain extent. The connection of the primary particles of the aggregate, also known as tissue, may be measured by particle size distribution (dynamic light scattering method or laser diffraction/light scattering method), electron microscope (either scanning or transmission method may be used) to grasp a growth degree thereof. Such a structure can efficiently form a conductive path between electrode active material particles. Therefore, excellent conductivity can be imparted to an electrode active material layer with less usage.

### (Dispersion Medium)

The dispersing agent composing the carbonaceous material dispersion for the all-solid lithium-ion rechargeable battery according to the first aspect of the present disclosure contains at least an ester solvent. The ester solvent is used because the polyvinyl butyral is mainly used as the dispersing agent in the carbonaceous material dispersion for the all-solid lithium-ion rechargeable battery according to the first aspect of the present disclosure, as described below, and the ester solvent shows good solubility in the polyvinyl butyral, and is hydrophobic, and has low reactivity with solid electrolyte.

In addition, the dispersion medium according to the present disclosure is not particularly limited as long as the dispersion medium shows good solubility in the above-mentioned polyvinyl butyral as the dispersing agent, and a mixing ratio of the ester solvent in the dispersion medium is not particularly limited. However, in order to obtain a good dispersion, preferably, for example, by mass, 10% or more, more preferably 20% or more of the ester solvent is contained. Of course, it is one of the preferred embodiments that all (100% by mass) of the dispersion medium is composed of the ester solvent.

In addition, as an ester solvent, as long as exhibiting good solubility in the polyvinyl butyral and low reactivity with the solid electrolyte, there is no particular limitation on the ester solvent used. For example, a carboxylic ester represented by R¹—COOR² (where R¹ is a C1-C8 hydrocarbyl and R² is a C2-C8 alkyl in the formula) may be used.

Specifically, for example, the following solvents may be used alone or in combination: n-propyl acetate, butyl acetate, ethyl propionate, propyl propionate, butyl propionate, amyl propionate, hexyl propionate, heptyl propionate, octyl propionate, ethyl butyrate, propyl butyrate, butyl butyrate, amyl butyrate, hexyl butyrate, heptyl butyrate, octyl butyrate, ethyl valerate, propyl valerate, butyl valerate, amyl valerate, hexyl valerate, heptyl valerate, octyl valerate, ethyl hexanoate, propyl hexanoate, butyl hexanoate, amyl hexanoate, hexyl hexanoate, heptyl hexanoate, octyl hexanoate, ethyl heptanoate, propyl heptanoate, butyl heptanoate, pentyl heptanoate, hexyl heptanoate, heptyl heptanoate, octyl heptanoate, ethyl octanoate, propyl octanoate, butyl octanoate, amyl octanoate, hexyl octanoate, heptyl octanoate, octyl octanoate, and the like.

N-propyl acetate, butyl butyrate, butyl valerate, butyl hexanoate, amyl butyrate, amyl valerate, amyl hexanoate, hexyl butyrate, hexyl valerate, and hexyl hexanoate are preferred, and butyl butyrate is particularly preferred.

In addition, the dispersion medium according to the present disclosure is not particularly limited as other solvents that can be used together with the ester solvent, as long as the solubility of the resin component of the ester solvent and the dispersibility to the carbonaceous materials are not greatly impaired, but nonpolar solvents are preferably used. If a nonpolar solvent is used, a problem that an ionic conductivity of the solid electrolyte decreases when a polar solvent such as water or NMP is used can be prevented.

As to the dispersion medium mentioned the present disclosure, the nonpolar solvent that can be used together with the ester solvent in the present disclosure is not particularly limited, and specifically includes, for example, non-aqueous straight-chain and/or branched-chain or cyclic alkanes having 4 to 30 carbon atoms, such as pentane, hexane, heptane, octane, nonane, decane, undecane, dodecane, cyclopentane, cyclohexane, cycloheptane, cyclooctane, methylcyclohexane, and the like; straight-chain and/or branched-chain and/or cyclic alkyl halides having 1 to 30 carbon atoms, such as dichloromethane, chloroform, tetrachloromethane, dichloroethane, trichloroethane, tetrachloroethane, and chlorocyclohexane, and the like; aromatic compounds having 6 to 22 carbon atoms such as benzene, toluene, xylene, mesitylene, and the like; hydrogenated aromatic compounds having 10 to 22 carbon atoms, such as tetralin, cis-decalin, trans-decalin, and the like; halogenated aromatic compounds having 6 to 22 carbon atoms, such as chlorobenzene, fluorobenzene, dichlorobenzene or difluorobenzene, trichlorobenzene or trifluorobenzene, chloronaphthalene or fluoronaphthalene, and the like; linear and/or branched and/or cyclic ethers such as diethyl ether, dipropyl ether, tert-butyl methyl ether, tert-amyl methyl ether, tert-amyl ethyl ether, dimethoxyethane, diethoxyethane, methoxybenzene, methylthiobenzene, ethoxybenzene, petroleum ether, and the like; linear and/or branched and/or cyclic ketones such as acetone, trichloroacetone, butanone, pentanone, hexanone, heptanone, octanone, nonanone, cyclopentanone, cyclohexanon e, acetophenone, acetylacetone, and the like; linear and/or branched and/or cyclic nitroalkanes such as nitromethane, nitroethane, nitrocyclohexane, and the like; aromatic compounds having 6 to 22 carbon atoms such as nitrobenzol, and the like; Straight-chain and/or branched-chain and/or cyclic amines, preferably tert-butylamine, diaminoethane, diethylamine, triethylamine, tributylamine, pyrrolidine, piperidine, morpholine, N-methylaniline, N,N-dimethylaniline and the like; silicone oils such as hexamethyldisilazane, diphenyldimethylsilane, chlorophenyltrimethylsilane, phenyltrimethylsilane, phenylenetris(trimethylsiloxy)silane, phenyltris(trimethylsiloxy)silane, polydimethylsiloxane, tetraphenyltetramethyltrisiloxane, poly(3,3,3-trifluoropropylsiloxane), 3,5,7-triphenylmethylpentasiloxane, 3,5-diphenyloctamethyltetrasiloxane, 1,1,5,5-tetraphenyl-1,3,3,5-tetramethyl-trisiloxane, and hexamethylcyclotrisiloxane; fluorine-containing solvents such as hydrofluoroethers, chlorodifluoromethane, 1,1,1,2-tetrafluoroethane, pentafluoroethane, difluoromethane, trifluoromethane, 1,1,1,2,3,3,3-heptafluoropropane, 1,1-difluoroethane, 1,1,1,3,3,3-hexafluoropropane, octafluoropropane, and the like; or a mixture of the above-mentioned nonpolar solvents in an arbitrary ratio.

As the nonpolar solvents, the cyclohexane, the normal hexane, the benzene, the toluene, the xylene and the like are particularly preferred.

The dispersion medium mentioned in the present disclosure are preferably composed of the above-mentioned ester solvents, or a mixed solvent of the ester solvent and the nonpolar solvent. In the mixed solvent, the content of the ester solvent is not less than 10% and less than 100% by mass, the content of the nonpolar solvent is not less than 0% and less than 90% by mass (the total mass is 100%).

### (Dispersing Agent)

The dispersing agent composing the carbonaceous material dispersion for the all-solid lithium-ion rechargeable battery according to the first aspect of the present disclosure contains at least polyvinyl butyral.

In an embodiment, as the dispersing agent, it is preferable that the polyvinyl butyral is a main component, especially not less than 80%, and even more preferably all of the dispersing agent, that is, 100% of the dispersing agent is polyvinyl butyral. In the carbonaceous material dispersion for the all-solid lithium-ion rechargeable battery, by using the polyvinyl butyral as the dispersing agent and combining with the above-mentioned ester solvent as the dispersion medium in this way, good dispersibility of the carbonaceous material in the carbonaceous material dispersion can be obtained, and low viscosity can be achieved. In addition, as described below, in the preparation of the slurry for the electrode of the all-solid lithium-ion rechargeable battery, when mixed with electrode active materials, solid components can be dispersed with low viscosity and high concentration. Moreover, the dispersing agent has the functions of moderately increasing the viscosity of the slurry, reducing a settling speed of materials constituting the electrode, such as electrode active materials and carbonaceous material, and uniformly coating the slurry on a current collector. Moreover, the dispersing agent can bond materials constituting the electrode, such as active materials, active materials and conductive additives, with moderate strength, adhesiveness and conductivity.

Polyvinyl butyral is not particularly limited, but if the hydroxyl content is low, specifically, for example, the hydroxyl content in a polymer is not less than 5% and less than 25% by mass, more preferably not less than 10% and not more than 20% by mass, and even more preferably not less than 12.5% and not more than 17.5% by mass, the polyvinyl butyral is preferable because the polyvinyl butyral has good solubility with respect to the above-mentioned ester solvent as the dispersion medium. In addition, although it is not particularly limited, it is preferable that an acetic acid group content of the polyvinyl butyral is about 1 to 7% by mass. As for viscosity, it is preferable that, measured at 20° C. based on DIN53015, the ethanol solution with 10% polyvinyl butyral by mass has a solution viscosity of about 10 to100 mPa·s, and especially about 20 to 60 mPa·s.

Regarding the dispersing agent, other dispersing agents that can be used in combination with the polyvinyl butyral, for example, resin-based dispersing agents besides polyvinyl butyral, surfactants exemplified below, and the like may be included.

### (Other Resin-Based Dispersing Agents)

Besides polyvinyl butyral, as the resin-based dispersing agent, polyvinyl acetal, polyvinyl acetate, polyester resin, epoxy resin, polyether resin, alkyd resin, polyurethane resin and the like may be used. When the dispersing agent is compounded with the above other resin-based components in addition to polyvinyl butyral, a combination proportion is that: the proportion of polyvinyl butyral is not less than 80% and less than 100% by mass, and the proportion of the above other components is less than 20% and not less than 0% by mass (100% by mass in total). If the other components is less than 20% by mass, the viscosity of the carbonaceous material dispersion according to the present disclosure at 25° C. can be kept at a desired value, specifically, for example, less than 500 mPa·s, and when the prepared slurry is finally coated on the current collector, the adhesion between active materials, active materials and conductive additives, and other materials composing the electrode can be improved.

### (pH Regulator)

In the carbonaceous material dispersion for the all-solid lithium-ion rechargeable battery according to the first aspect of the present disclosure, a pH regulator may be added as necessary.

The pH regulator, for example, may include tertiary amines, secondary amines, primary amines, cyclic amines, alkanolamines or aminoalcohols as compounds having amino groups and hydroxyl groups in the alkane skeleton, or amine compounds such as diglycol ammonium salt, tris(hydroxymethyl)aminomethane (THAM), morpholine and other amines. Although not particularly limited, 2-methylaminoethanol, 2-amino-1-butanol, 4-ethylamino-1-butanol, triethylamine, 2-amino-2-ethyl-1,3-propanediol (AEPD), 2-amino-2-methyl-1-propanol (AMP) and THAM are particularly preferred.

### (Surfactant)

In the carbonaceous material dispersion for the all-solid lithium-ion rechargeable battery according to the first aspect of the present disclosure, a surfactant may be added as a dispersing agent as necessary.

The surfactant is not particularly limited, but examples include anionic surfactants such as sodium dodecyl benzene sulfonate and sodium dodecyl sulfate, cationic surfactants such as tetramethylammonium chloride, nonionic surfactants such as polyoxyethylene alkyl ether compounds and polyoxyethylene fatty acid ester compounds.

As a dispersing agent, when the above-mentioned other components are mixed in addition to polyvinyl butyral, a combination proportion is that: the proportion of polyvinyl butyral is not less than 80% by mass and less than 100% by mass, and the proportion of the above-mentioned other components is less than 20% by mass and not less than 0% by mass (100% by mass in total). If the other components is less than 20% by mass, the viscosity of the carbonaceous material dispersion according to the present disclosure at 25° C. can be kept at a desired value, specifically, for example, not more than 500 mPa·s, and when the prepared slurry is finally coated on the current collector, the adhesion between active materials, active materials and conductive additives, and other materials constituting the electrode can be improved.

### (Mixing Proportion in the Dispersion)

In the carbonaceous material dispersion for the all-solid lithium-ion rechargeable battery according to the first aspect of the present disclosure, modifications may be made as follows: in the dispersion medium containing at least the ester solvent, with respect with the total mass of the dispersion, the carbonaceous material accounts for 10 to 25% by mass, more preferably 12 to 18% by mass. In addition, the dispersing agent is 5 to 40% of the carbonaceous material by mass (i.e., assuming the total mass of the carbonaceous material is 100%), preferably not less than 5% and less than 20% by mass, and more preferably not less than 6% and less than 12% by mass. If the masses of the carbonaceous material and the dispersing agent are kept within these ranges, it is possible to form a dispersion containing a high concentration of carbonaceous material while maintaining good dispersibility and low viscosity of the carbonaceous material. In addition, if the concentration of the carbonaceous material is less than the above proportion, energy required for removing the solvent in manufacturing the product may increase, and a transportation cost of the dispersion and a cost of the solvent may increase. However, if the concentration of carbonaceous material is more than the above ratio, it is difficult to obtain sufficient fluidity and the operability becomes poor. In addition, if the concentration of the dispersing agent is less than the above proportion, it is difficult to obtain fluidity, while if the concentration of the dispersing agent is more than the above proportion, there is a fear that the conductivity of the final product may decrease due to the increase of the proportion of insulating components in the dispersion. In addition, if it is desired to improve the adhesiveness of the final product, modification may be considered in the following manner: the mass of the dispersing agent is preferably 20 to 40%, more preferably 25 to 35%, relative to the mass of the carbonaceous material (that is, assuming the mass of the carbonaceous material is 100%).

In addition, as described above, when the pH regulator is mixed, an added amount of the pH regulator is set to be 0.01 to 5%, more preferably about 0.05 to 3%, relative to the total amount of the dispersion. By adding the pH regulator within this range, a better dispersibility of the carbonaceous materials can be obtained.

### (Viscosity of the Dispersion)

Then, the viscosity of the carbonaceous material dispersion according to the present disclosure can be made not more than 500 mPa·s at 25° C., preferably about 50 to 300 mPa·s, by, for example, dispersing the components with the above proportions.

Further, in this specification, the viscosity of the carbonaceous material dispersion refers to: a value measured by a B-type viscometer immediately after the dispersion is fully stirred by a spatula (for example, for one minute) at a measuring temperature of 25° C. and a rotor speed of the B-type viscometer of 60 rpm.

The carbonaceous material dispersion according to the present disclosure has the above-described components and mixing proportions, and exhibits the desired viscosity, so that the carbonaceous material can be uniformly dispersed at a high concentration, exhibiting stable fluidity. When the carbonaceous material dispersion is mixed with electrode active materials to prepare the slurry for the electrode of the all-solid lithium-ion rechargeable battery, the electrode active material can be dispersed at a high concentration with a moderately low viscosity suitable for manufacture.

This characteristic can be objectively evaluated by facts that, for example, the viscoelasticity of the carbonaceous material dispersion according to the present disclosure at 25° C. has a minimum value when the shearing velocity is in the range of 10 to 1,000 s⁻¹, more preferably in the range of 10 to 500 s⁻¹, and even more preferably in the range of 10 to 100 s⁻¹.

Further, in this specification, the viscoelasticity of the carbonaceous material dispersion refers to: the value with the shearing velocity range indicating the minimum value of the viscosity as an index when the temperature condition of the dispersion is 25° C. and the shearing velocity is changed from 0.1 s⁻¹ to 1,000 s⁻¹ and the shearing viscosity is measured by a rheometer.

### (Manufacturing of the Carbonaceous Material Dispersion)

Methods for manufacturing the carbonaceous material dispersion for the all-solid lithium-ion rechargeable battery according to the first aspect of the present disclosure are not particularly limited, where the carbonaceous material and the dispersing agent are added, stirred and mixed in the above-mentioned prescribed proportion in an ester solvent as a dispersion medium, and dispersed.

A dispersion device is not particularly limited, and a dispersion machine commonly used for pigment dispersion and the like may be used. For example, examples include mixers such as dispersers, homogenizers and planetary mixers, homogenizers (“CLEARMIX” manufactured by M-Technical, “FILMICS” manufactured by PRIMIX, “ABRAMIX” manufactured by Silverson), paint regulator (manufactured by Red Devil), paint mixers (“PUC Paint Mixer” manufactured by PUC, and “paint mixer MX” manufactured by IKA), cone mill (“cone mill MKO” manufactured by IKA), ball mills, sand mills (“Dyno mill” manufactured by Shinmaru Enterprises), grinders, bead mill (“DCP mill” manufactured by Eirich), sand mills and other medium dispersion machines, wet jet mills (“GenusPY” manufactured by Genus, “Star Burst” manufactured by Sugino Machine, “Nanomizer” manufactured by Nanomizer, and the like), “CLEAR SS-5” manufactured by M-Technic, “MICROS” manufactured by Nara Machinery, and other roller mills, but not limited to this.

Preferably, the carbonaceous material is finally dispersed and prepared by a medium mill, especially the medium mill using beads with an average particle size of 0.05 to 2 mm. More preferably, before the dispersion treatment by the medium mill, the dispersion treatment is carried out by using a shearing type dispersion device described in detail below, and then the dispersion treatment is carried out by the medium mill, thereby completing the preparation.

In addition, if the particle size of the bead used for dielectric grinding is too small, there is a fear that carbonaceous materials such as primary aggregates of carbon black may be finely broken, and in addition, dispersion treatment requires too much energy. In addition, due to the difficulty in operation, it is preferable that the average particle size of the bead is not less than 0.05 mm, especially not less than 0.5 mm. However, if the bead is too large, there are concerns that the number of beads per unit volume decreases, so the dispersion efficiency decreases, the crushing of the carbonaceous materials is insufficient, and the particles of the carbonaceous materials exist in a state with a relatively large aspect ratio, so that the liquid properties of paints and coating agents cannot be obtained. Therefore, it is preferable that the average diameter of the bead is not more than 2 mm, particularly not more than 1.5 mm.

A material of the bead of the dispersion medium used in the medium mill is not particularly limited, and for example, alumina, zirconia, steel, chrome steel, glass, etc. can be exemplified, but if the pollution to the product and the kinetic energy caused by specific gravity are considered, the zirconia bead is preferably used.

Shapes of the bead are not particularly limited, and generally spherical beads are used.

Structures of the medium mill are not particularly limited, and various well-known medium mills may be applied. Specifically, various well-known grinders, sand mills, bead mills and the like may be used.

In addition, there is no particular limitation as long as a filling ratio of the bead into a container is determined according to the container, a stirring mechanism, a structure, and the like. However, if the ratio is too low, there is a fear that the carbonaceous material cannot be fully crushed or cut. However, if the ratio is too high, there are concerns that the rotation requires a large driving force, and in addition, the pollution to the treated medium is increased due to the wear of the beads. Therefore, it is preferable that the filling ratio of the beads is set to be, for example, about 70 to 85% by volume of an effective volume of the container.

In addition, operating conditions including processing time, number of revolutions of a shaft, internal pressure of the container, motor load and others depend on the mass of the carbonaceous material and characteristics of the resin to be dispersed, especially on the viscosity, the compatibility with the carbonaceous material and the like, as long as the conditions are appropriately set according to the object.

In addition, before the dispersion treatment by the medium mill, pre-dispersion treatment may be carried out by using other stirring devices, such as a shearing mixer such as a disperser and a homogeneous mixer.

By carrying out the dispersion treatment in this way, a dispersion with a viscosity not more than 500 mPa·s at 25° C., preferably about 50 to 300 mPa·s, is prepared.

### <Slurry for an Electrode of an All-Solid Lithium-Ion Rechargeable Battery>

The carbonaceous material dispersion according to the first aspect of the present disclosure described in detail above may contain the following electrode active materials and be prepared into an electrode slurry.

That is, a slurry for an electrode of the all-solid lithium-ion rechargeable battery according to a second aspect of the present disclosure is a slurry for the electrode of the all-solid lithium-ion rechargeable battery, formed the carbonaceous material, the dispersing agent, a binder resin and a cathode active material or an anode active material mixed in a dispersion medium. The dispersion medium contains at least the ester solvent, and the dispersing agent at least contains polyvinyl butyral. In addition, in solid components of the slurry, the mass of the dispersing agent is 5 to 40% of the mass of the carbonaceous material.

In a preferred embodiment of the slurry for the electrode of the all-solid lithium-ion rechargeable battery according to the second aspect of the present disclosure, in the solid components of the slurry, it is preferable that the mas of the dispersing agent is not less than 5% and less than 20%, more preferably not less than 6% and less than 12% of the mass of the carbonaceous material.

In other embodiments of the slurry for the electrode of the all-solid lithium-ion rechargeable battery according to the second aspect of the present disclosure, in the solid components of the slurry, the mass of the dispersing agent is 20 to 40%, and more preferably 25 to 35%, of the mass of the carbonaceous material.

In addition, the manufacturing process of the slurry for the electrode of the all-solid lithium-ion rechargeable battery and the order of adding the components according to the second aspect of the present disclosure are not limited, and for example, may be set in any of the following ways: (a) manufacturing the slurry for the electrode of the all-solid lithium-ion rechargeable battery by dispersing and mixing all the components at one time; (b) after preparing the carbonaceous material dispersion according to the first aspect of the present disclosure, mixing a cathode active material or an anode active material into the carbonaceous material dispersion to obtain the slurry for the electrode of the all-solid lithium-ion rechargeable battery; and (c) preparing the carbonaceous material dispersion in which a carbonaceous material (and the dispersing agent) is dispersed in a part of the dispersion medium and the electrode active material dispersion in which the cathode active material or the anode active material (and the dispersing agent) is dispersed in a part of the dispersion medium, and mixing the carbonaceous material dispersion with the electrode active material dispersion to obtain the slurry for the electrode of the all-solid lithium-ion rechargeable battery.

(Dispersion medium, Carbonaceous Material, Dispersing Agent and pH Regulator)

The dispersion medium, the carbonaceous material and the dispersing agent in the components of the slurry for the electrode of the all-solid lithium-ion rechargeable battery according to the second aspect of the present disclosure are the same as those described with respect to the carbonaceous material dispersion according to the first aspect of the present disclosure, and the description will not be described in detail here to avoid repetition. In addition, in the slurry for the electrode of the all-solid lithium-ion rechargeable battery according to the second aspect of the present disclosure, as in the case of the carbonaceous material dispersion according to the first aspect of the present disclosure, the above-mentioned pH regulator may be added as necessary.

### (Electrode Active Material)

In the slurry for the electrode of the all-solid lithium-ion rechargeable battery according to the second aspect of the present disclosure, the cathode active material, which is mixed, is not particularly limited, and metal oxides, metal compounds such as metal sulfides and conductive polymers that can dope or intercalate lithium ions may be used.

For example, examples include oxides of transition metals such as Fe, Co, Ni and Mn, complex oxides with lithium, inorganic compounds such as transition metal sulfides, and the like. Specifically, there are transition metal oxide powders such as MnO, V₂O₅, V₆O₁₃, and TiO₂, composite oxide powders of lithium and transition metals such as lithium nickelate, lithium cobaltate, lithium manganate, and lithium manganate with spinel structure, ferrous lithium phosphate-based materials as phosphate compounds with olivine structure, and transition metal sulfide powders such as TiS₂ and FeS. In addition, conductive polymers such as polyaniline, polyacetylene, polypyrrole and polythiophene may also be used. In addition, the above-mentioned inorganic compounds and organic compounds may be used in combination.

On the other hand, in the slurry for the electrode of the all-solid lithium-ion rechargeable battery according to the second aspect of the present disclosure, as long as lithium ions can be doped or intercalated, there is no particular limitation. For example, examples include metal Li, alloy systems such as tin alloy, silicon alloy and lead alloy, metal oxide systems such as LiXFe₂O₃, LiXFe₃O₄, LiXWO₂, lithium titanate, lithium vanadate and lithium silicate, conductive polymer systems such as polyacetylene and poly-p-phenylene, amorphous carbonaceous materials such as soft carbon and hard carbon, artificial graphite such as graphitized carbonaceous material, or carbonaceous powder such as natural graphite, carbon black, mesophase carbon black, resin sintered carbonaceous material, vapor-grown carbon fiber, carbon fiber and other carbonaceous materials. These anode active materials may also be used in one form or in combination.

The average particle size of these electrode active materials is preferably in a range of 0.05 to 100 μm, more preferably in a range of 0.1 to 50 μm. The average particle size of the electrode active material mentioned in this specification refers to the average particle size measured by an electron microscope.

### (Binder Resin)

In the slurry for the electrode of the all-solid lithium-ion rechargeable battery according to the second aspect of the present disclosure, the binder resin mixed in the dispersion medium is not particularly limited, but a polymer that is insoluble in water may be used, specifically, polyvinylidene fluoride, polytetrafluoroethylene, polyimide, polyamide, polyamideimide, butadiene rubber, isobutylene rubber, styrene-butadiene rubber, ethylene-propylene rubber, nitrile rubber and the like may be used. The styrene butadiene rubber is preferably used. In addition, the same dispersing agent as the resin-based dispersing agent that can be mixed in the carbonaceous material dispersion according to the first aspect of the present disclosure may also function as a binder resin.

As a device for manufacturing the electrode slurry, the same device as that used in preparing the dispersion of the present disclosure described above may be used.

In an embodiment of the slurry for the electrode of the all-solid lithium-ion rechargeable battery according to the second aspect of the present disclosure, the workability can be improved by using the components specified above, when a solid content concentration of the slurry is 65 to 75% by mass (for example, when the mass of the dispersing agent is not less than 5% and less than 20% of the mass of the carbonaceous material), the viscosity of the slurry at 25° C. may be made to be 500 to 5,000 mPa·s, and more preferably, 1,000 to 4,000 mPa·s.

In an embodiment of the slurry for the electrode of the all-solid lithium-ion rechargeable battery according to the second aspect of the present disclosure, the workability can be improved by using the components specified above, when a solid content concentration of the slurry is 77 to 87% by mass (for example, when a use level of the dispersing agent is 20 to 40% by mass relative to the mass of the carbonaceous material), the viscosity of the slurry at 25° C. may be made to be 1000 to 10,000 mPa·s, and more preferably, 1,000 to 5,000 mPa·s.

### EXAMPLES

The present disclosure will be described in detail below according to the embodiments, and the present disclosure is not limited to the following examples as long as the present disclosure does not depart from the scope of the present disclosure. In the examples, “part(s)” represent part(s) by mass and “%” represents % by mass.

### Example 1

Assuming a total mass of a dispersion to be 100%, butyl butyrate (manufactured by Tokyo Chemical Industry) as a dispersion medium was 82.5% by mass, polyvinyl butyral (S-LEC BL, manufactured by Sekisui Chemical Co., Ltd.) as a dispersing agent was 1.5% by mass (10% by mass of the acetylene black), acetylene black (Denka Black (trade name) granules, manufactured by DENKA Co., Ltd.) were 15% by mass, and 2-amino-2-ethyl-1 and 3-propylene glycol were 1% by mass, which were mixed and then the mixture was dispersed by a laboratory bead mill (manufactured by AIMEX Co., Ltd.).

In addition, regarding the dispersion treatment by the bead mill, zirconia beads with a diameter of 1 mm were used as the beads, a filling rate of the beads in a container was set to 30% of the effective volume of the container, and a volume ratio of the dispersion to the beads was about 1: 1, and dispersion was carried out in the container at a rotating speed of about 2,000 rpm until a viscosity reached about 100 mPa·s.

After the carbonaceous material dispersion (acetylene black dispersion) prepared in this way was dispersed, the carbonaceous material dispersion was stood for not less than 24 hours, then its viscosity at 25° C. was measured to have the result of 104 mPa·s. A B-type viscometer (“TVB-15M” manufactured by TOKI SANGYO) was used for measurement. At the measurement temperature of 25° C. and the rotor speed of the B-type viscometer of 60 rpm, the composition was fully stirred and dispersed with a spatula, and the measurement was immediately carried out. No. 21 rotor was used. Then, a shearing velocity was changed from 0.1 s⁻¹ to 1,000 s⁻¹ by using a rheometer (“Kinexus” manufactured by MalvernPANalytica), and a shearing velocity was measured to confirm that the minimum value of the viscosity was in a range of 10 s⁻¹ to 1,000 s⁻¹ (250 s⁻¹).

18 parts of binder solution prepared by styrene-butadiene rubber dissolved in 10% by mass of butyl butyrate were added to 4 parts of the prepared carbonaceous material dispersion, and the mixture was uniformly mixed by using a revolution-rotation stirring defoamer to prepare a coating paste. The coating paste was coated on a glass plate by an applicator (manufactured by YOSHIMITSU) and dried at 100° C. for two hours under reduced pressure to obtain a coated film (a thickness after drying was 30 μm). A resistance value was measured with a low resistivity meter (“Loresta-GX” manufactured by Mitsubishi Chemical Analytech), and the result was 1,211 Ω, exhibiting excellent conductivity.

### Example 2

Compared with 10.0 g of the carbonaceous material dispersion prepared in Example 1 above, in the way that the concentration of all solid components was 65% by mass, 30.0 g of LiNi_{1/3}Co_{1/3}Mn_{1/3}O₂ powder (manufactured by Fujifilm Wako Pure Chemical, with a particle size of 1 to several μm) serving as a cathode active material, a binder solution formed by styrene-butadiene rubber dissolved into 10% by mass of butyl butyrate, butyl butyrate were mixed, and subjected to revolution and rotation by using a revolution-rotation stirring defoamer at a rotating speed of 1,200 rpm. After five minutes of treatment, the mixture became slurry exhibiting fluidity.

Here, the rheometer described above was used to measure whether the obtained slurry for forming a cathode electrode mixture layer has an appropriate viscosity at the time of coating. The measuring conditions of the rheometer were constant at 25° C. and the shearing speed of 10 s⁻¹. An average value obtained by measuring 5 points every 60 seconds was taken as the viscosity of the slurry.

The result was that the viscosity of the slurry was 3,746 mPa·s.

### Example 3

Assuming a total mass of a dispersion to be 100%, butyl butyrate as a dispersion medium was 83.2% by mass, polyvinyl butyral (S-LEC BL, manufactured by Sekisui Chemical Co., Ltd.) as a dispersing agent was 0.8% by mass (5.3% by mass relative to acetylene black), acetylene black (Denka Black (trade name) granules, manufactured by DENKA Co., Ltd.) were 15% by mass, and 2-amino-2-ethyl-1 and 3-propylene glycol were 1% by mass, which were mixed and then the mixture was dispersed by a bead mill.

In addition, the conditions of the dispersion treatment by the bead mill were the same as those in Example 1, except that the dispersion was carried out until the viscosity reached about 300 mPa·s.

The viscosity of the carbonaceous material dispersion (acetylene black dispersion) thus prepared was measured in the same manner as that in Example 1. The result was that the viscosity of the dispersion was 345 mPa·s. Then, as in Example 1, the shearing velocity was changed from 0.1 s⁻¹ to 1,000 s⁻¹ by using a rheometer, and the shearing velocity was measured to confirm that the minimum value of the viscosity was in the range of 10 s⁻¹ to 1,000 s⁻¹ (630 s⁻¹).

Then, as in Example 1, the dry coating film was prepared, and the result of measuring a resistance value was 1,079 Ω, exhibiting excellent conductivity.

### Example 4

Assuming a total mass of the dispersion to be 100%, the butyl butyrate as the dispersion medium was 81.5% by mass, the polyvinyl butyral (S-LEC BL, manufactured by Sekisui Chemical Co., Ltd.) as the dispersing agent was 2.5% by mass (16.7% by mass relative to acetylene black), the acetylene black (Denka Black (trade name) granules, manufactured by DENKA Co., Ltd.) were 15% by mass, and the 2-amino-2-ethyl-1 and 3-propylene glycol were 1% by mass, which were mixed and then the mixture was dispersed by a bead mill.

In addition, the conditions for the dispersion treatment by the bead mill were the same as those in Example 1.

The viscosity of the carbonaceous material dispersion (acetylene black dispersion) thus prepared was measured in the same manner as it in Example 1. The result was that the viscosity of the dispersion was 79 mPa·s.

Then, as in Example 1, the shearing velocity was changed from 0.1 s⁻¹ to 1,000 s⁻¹ by using a rheometer, and the shearing velocity was measured to confirm that the minimum value of the viscosity was in a range of 10 s⁻¹ to 1,000 s⁻¹ (250 s⁻¹).

Then, as in Example 1, the dry coating film was prepared, and the result of measuring a resistance value was 1,371 Ω, exhibiting excellent conductivity.

### Comparative Examples 1 and 2

As in Example 1, except that the cellulose acetate or polyvinylpyrrolidone (both manufactured by Kanto Chemical Co., Ltd.) were used instead of the polyvinyl butyral as the dispersing agent in Example 1, the dispersion treatment was carried out by using the bead mill.

However, in either case, the resin component was not successfully dissolved in the butyl butyrate as the dispersion medium, and the uniform dispersion of acetylene black could not be obtained.

### Comparative Example 3

Assuming a total mass of a dispersion to be 100%, the butyl butyrate as the dispersion medium was 83.4% by mass, the polyvinyl butyral (S-LEC BL, manufactured by Sekisui Chemical Co., Ltd.) as the dispersing agent was 0.6% by mass (4% by mass relative to acetylene black), the acetylene black (Denka Black (trade name) granules, manufactured by DENKA Co., Ltd.) were 15% by mass, and the 2-amino-2-ethyl-1 and 3-propylene glycol were 1% by mass, which were mixed and then the mixture was dispersed by a bead mill. However, the dispersion did not exhibit sufficient fluidity.

Example 5

Assuming a total mass of a dispersion to be 100%, the butyl butyrate as the dispersion medium was 81% by mass, the polyvinyl butyral (S-LEC BL, manufactured by Sekisui Chemical Co., Ltd.)

as the dispersing agent was 3% by mass (20% of the acetylene black), the acetylene black (Denka Black (trade name) granules, manufactured by DENKA Co., Ltd.) were 15% by mass, and the 2-amino-2-ethyl-1 and 3-propylene glycol were 1% by mass, which were mixed and then the mixture was dispersed by the bead mill. In addition, the conditions for the dispersion treatment by the bead mill were the same as those in Example 1.

The viscosity of the carbonaceous material dispersion (acetylene black dispersion) thus prepared was measured in the same manner as it in Example 1. The result was that the viscosity of the dispersion was 137 mPa·s. Then, as in Example 1, the shearing velocity was changed from 0.1 s⁻¹ to 1,000 s⁻¹ by using a rheometer, the shearing velocity was measured, and the result was that the minimum value of the viscosity was in a range of 10 s⁻¹ to 1,000 s⁻¹ (250 s⁻¹).

Then, as in Example 1, the dry coating film was prepared, and the result of measuring a resistance value was 1,953 Ω, exhibiting lower conductivity than those in Example 1 and Example 3.

### Example 6

Assuming a total mass of a dispersion to be 100%, the butyl butyrate (manufactured by Tokyo Chemical Industry) as the dispersion medium was 79% by mass, the polyvinyl butyral (S-LECBL, manufactured by Sekisui Chemical Co., Ltd.) as the dispersing agent was 5% by mass (33.3% by mass relative to acetylene black), the acetylene black (Denka Black (trade name) granules, manufactured by DENKA Co., Ltd.) were 15% by mass, and the 2-amino-2-ethyl-1 and 3-propylene glycol were 1% by mass, which were mixed and then the mixture was dispersed by the bead mill (manufactured by AIMEX).

In addition, regarding the dispersion treatment by the bead mill, the zirconia beads with a diameter of 1 mm were used as the beads, the filling rate of the beads in the container was 30% of the effective volume of the container, and the volume ratio of the dispersion to the beads was about 1:1, and dispersion was carried out in the container at a rotating speed of about 2,000 rpm until the viscosity reached about 100 mPa·s.

After the carbonaceous material dispersion (acetylene black dispersion) prepared in this way is dispersed, the carbonaceous material dispersion was stood for not less than 24 hours, then the viscosity at 25° C. was measured, and the result was 86 mPa·s. The A B-type viscometer (“TVB-15M” manufactured by TOKI SANGYO) was used for measurement. At the measurement temperature of 25° C. and a rotor speed of the B-type viscometer being 60 rpm, the composition was fully stirred and dispersed with a spatula, and the measurement was immediately carried out. No. 21 rotor was used. Then, the shearing velocity was changed from 0.1 s⁻¹ to 1,000 s⁻¹ by using a rheometer (“Kinexus” manufactured by MalvernPANalytica), and the shearing velocity was measured to confirm that the minimum value of the viscosity was in a range of 10 s⁻¹ to 1,000 s⁻¹ (90 s⁻¹).

### Example 7

As to the 10.0 g carbonaceous material dispersion prepared in Example 6 above, in the way that the concentration of all solid components was 80% by mass, 32.0 g of LiNi_{1/3}Co_{1/3}Mn_{1/3}O₂ powder (manufactured by Fujifilm Wako Pure Chemical, with a particle size of 1 to several μm) serving as the cathode active material and the butyl butyrate were mixed, and subjected to revolution and rotation by means of a revolution-rotation stirring defoamer at a rotating speed of 1,200 rpm. After five minutes of treatment, the mixture became slurry exhibiting fluidity.

Here, the rheometer described above was used to measure whether the obtained slurry for forming a cathode electrode mixture layer became an appropriate viscosity at the time of coating. The measuring conditions of the rheometer were constant at 25° C. and the shearing speed of 10 s⁻¹. An average value obtained by measuring 5 points every 60 seconds was taken as the viscosity of the slurry.

In the measurement result the viscosity of the sizing agent was 1,228 mPa·s.

### Example 8

Assuming a total mass of the dispersion to be 100%, the butyl butyrate as the dispersion medium was 78% by mass, the polyvinyl butyral (S-LEC BL, manufactured by Sekisui Chemical Co., Ltd.) as the resin composite was 6% by mass (40.0% by mass relative to acetylene black), the acetylene black (Denka Black (trade name) granules, manufactured by DENKA Co., Ltd.) were 15% by mass, and the 2-amino-2-ethyl-1 and 3-propylene glycol were 1% by mass, which were mixed and then the mixture was dispersed by a bead mill.

In addition, the conditions for dispersion treatment by the bead mill were the same as those in Example 6.

The viscosity of the carbonaceous material dispersion (acetylene black dispersion) thus prepared was measured in the same manner as it in Example 5. In the result the viscosity of the dispersion was 106 mPa·s.

Then, as in Example 6, the shearing velocity was changed from 0.1 s⁻¹ to 1,000 s⁻¹ by using the rheometer, and the shearing velocity was measured to confirm that the minimum value of the viscosity was in a range of 10 s⁻¹ to 1,000 s⁻¹ (160 s⁻¹).

### Comparative Examples 4 and 5

As in Example 1, except that the cellulose acetate or polyvinylpyrrolidone (both manufactured by Kanto Chemical Co., Ltd.) were used instead of the polyvinyl butyral as the resin composite in Example 6, the dispersion treatment was carried out by the bead mill.

However, in either case, the resin component was not successfully dissolved in the butyl butyrate which is used as the dispersion medium, and no uniform dispersion of acetylene black could be obtained.

### Example 9

Assuming a total mass of a dispersion to be 100%, the butyl butyrate as the dispersion medium was 82.5% by mass, the polyvinyl butyral (S-LEC BL, manufactured by Sekisui Chemical Co., Ltd.) as the dispersing agent was 2% by mass (13.3% of the acetylene black), the acetylene black (Denka Black (trade name) granules, manufactured by DENKA Co., Ltd.) were 15% by mass, and the 2-amino-2-ethyl-1 and 3-propylene glycol were 1% by mass, which were mixed and then the mixture was dispersed by a bead mill.

In addition, the conditions for dispersion treatment by the bead mill were the same as those in Example 6.

The viscosity of the carbonaceous material dispersion (acetylene black dispersion) thus prepared was measured in the same manner as it in Example 5. In the result the viscosity of the dispersion was 72 mPa·s.

Then, as in Example 6, the shearing velocity was changed from 0.1 s⁻¹ to 1,000 s⁻¹ through the rheometer, and the shearing velocity was measured to confirm that the minimum value of the viscosity was in a range of 10 s⁻¹ to 1,000 s⁻¹ (250 s⁻¹).

### Example 10

Under the same conditions as in Example 7, the carbonaceous material dispersion prepared in Example 9 was mixed with the positive active material and treated by the revolution-rotation stirring defoamer, and then the butyl butyrate was added under the same conditions as in Example 7 and treated by the revolution-rotation stirring defoamer. As a result, the mixture did not show sufficient fluidity. However, the result of adding the butyl butyrate and treating by the revolution-rotation stirring defoamer until the mixture showed sufficient fluidity, was that a slurry with a solid content concentration of 75% by mass but having fluidity was obtained.

Comparative Example 6

Assuming the total mass of the dispersion to be 100%, the butyl butyrate as the dispersion medium was 76% by mass, the polyvinyl butyral (S-LEC BL, manufactured by Sekisui Chemical Co., Ltd.) as the dispersing agent was 8% by mass (53.3% by mass relative to acetylene black), the acetylene black (Denka Black (trade name) granules, manufactured by DENKA Co., Ltd.) were 15% by mass, and the 2-amino-2-ethyl-1 and 3-propylene glycol were 1% by mass, which were mixed and then the mixture was dispersed by the bead mill. In addition, the conditions for dispersion treatment by the bead mill were the same as those in Example 6.

The viscosity of the carbonaceous material dispersion (acetylene black dispersion) thus prepared was measured in the same manner as it in Example 6. According to the result the viscosity of the dispersion was 93 mPa·s. Then, as in Example 6, the shearing velocity was changed from 0.1 s⁻¹ to 1,000 s⁻¹ through the rheometer, the shearing velocity was measured. According to the result, the minimum value of the viscosity was not within the measurement range.

1. A carbonaceous material dispersion, which is a carbonaceous material dispersion with carbonaceous materials and dispersing agents dispersed in a dispersion medium for an all-solid lithium-ion rechargeable battery, wherein,
the dispersion medium contains at least an ester solvent, and the dispersing agent contains at least polyvinyl butyral;
in the dispersion the carbonaceous material accounts for 10 to 25% of the total mass of the dispersion, and the dispersing agent is 5 to 40% of the carbonaceous material by mass; and
the carbonaceous material dispersion has a viscosity of not more than 500 mPa·s at 25° C.

2. The carbonaceous material dispersion according to claim 1, wherein, the mass of the dispersing agent is not less than 5% and less than 20% of the mass of the carbonaceous material.

3. The carbonaceous material dispersion according to claim 1, wherein, the mass of the dispersing agent is 20% to 40% of the mass of the carbonaceous material.

4. The carbonaceous material dispersion according to claim 1, wherein, the carbonaceous material dispersion has a viscoelasticity with a minimum value at in a shearing velocity range of 10 to 1,000 s⁻¹ 25° C.

5. The carbonaceous material dispersion according to claim 1, wherein, the dispersion medium contains an ester solvent accounting for not less than 10% of the dispersion medium by mass.

6. The carbonaceous material dispersion according to claim 1, wherein, the ester solvent is at least one selected from the group consisting of n-propyl acetate, butyl butyrate, butyl valerate, butyl hexanoate, amyl butyrate, amyl valerate, amyl caproate, hexyl butyrate, hexyl valerate and hexyl hexanoate.

7. The carbonaceous material dispersion according to claim 6, wherein, the ester solvent is butyl butyrate.

8. The carbonaceous material dispersion according to claim 1, wherein, the carbonaceous material is carbon black.

9. The carbonaceous material dispersion according to claim 8, wherein, the carbon black is acetylene black.

10. The carbonaceous material dispersion according to claim 1, wherein, the carbonaceous material dispersion further contains a pH regulator.

11. A slurry for an electrode of an all-solid lithium-ion rechargeable battery, comprising a carbonaceous material, a dispersing agent, a binder resin and a cathode active material or an anode active material mixed in a dispersion medium, wherein, the dispersion medium contains at least an ester solvent, the dispersing agent contains at least polyvinyl butyral, and in solid components of the slurry, the dispersing agent is 5% to 40% of the carbonaceous material by mass.

12. The slurry for the electrode of the all-solid lithium-ion rechargeable battery according to claim 11, wherein, the mass of the dispersing agent is not less than 5% and less than 20% of the mass of the carbonaceous material.

13. The slurry for the electrode of the all-solid lithium-ion rechargeable battery according to claim 11, wherein, the mass of the dispersing agent is 20% to 40% of the mass of the carbonaceous material.

14. The slurry for the electrode of the all-solid lithium-ion rechargeable battery according to claim 12, wherein, when the solid components of the slurry have a concentration of 65 to 75% by mass, the slurry has a viscosity of 500 to 5,000 mPa·s at 25° C.

15. The slurry for the electrode of the all-solid lithium-ion rechargeable battery according to claim 13, wherein, when the solid components of the slurry have a concentration of 77 to 87% by mass, the slurry has a viscosity of 1,000 to 10,000 mPa·s at 25° C.
